(19) United States
(12) Patent Application Publication
(10) Pub. No.: US 2021/0252508 A1
(43) Pub. Date: Aug. 19, 2021

(54) SAMPLE CARTRIDGES

(71) Applicant: Heska Corporation, Loveland, CO (US)

(72) Inventor: Andrew Hinsch, San Diego, CA (US)

(21) Appl. No.: 17/177,059

(22) Filed: Feb. 16, 2021

Related U.S. Application Data
(60) Provisional application No. 62/977,231, filed on Feb. 15, 2020.

(51) Int. Cl. B01L 3/00

(52) U.S. Cl. CPC B01L 3/502715; B01L 2400/0409; B01L 2300/0816

(57) ABSTRACT

A versatile cartridge is disclosed especially designed to collect and store varying samples, such as urine or fecal matter, and hold the sample while the sample is processed by a centrifuge, and to hold the sample while the sample is examined from a top or bottom view by an optical system within an instrument or analyzer.

This Patent Application claims priority to U.S. Provisional Patent Application Ser. No. 62/977,231, filed Feb. 15, 2020, the content of which is hereby incorporated by reference herein in its entirety into this disclosure.

### BACKGROUND OF THE SUBJECT DISCLOSURE

### Field of the Subject Disclosure

The present subject disclosure relates to cartridges. More specifically, the present subject disclosure relates to cartridges for containing and analyzing a variety of samples, those samples being of varying properties, including, for example, differing densities, turbidity, and origin.

### Background of the Subject Disclosure

Obtaining and analyzing fluid or biological material samples, such as urine or fecal matter, from humans or animals is a standard and useful practice in the medical field. Often, such samples are collected, stored, and handled using different techniques and procedures. Further, a different set of automated analyzers, machines, or systems are used to analyze the content and composition of the urine or fecal sample. Because of the cost of the equipment and space needed to house them, medical offices often send samples out to a laboratory to analyze, having to wait for hours or even days for the results. In the meantime, the patient may be suffering from an ailment.

Thus, conventional techniques of collecting, storing, and analyzing different samples often result in inefficiencies and high costs as each of the samples must be processed in its own technique or machine, often away from the medical office where the sample was collected.

### SUMMARY OF THE SUBJECT DISCLOSURE

The present subject disclosure uses urine or fecal matter as non-limiting examples of two different types of materials which may be contained and examined within the cartridge. However, the present subject disclosure is not limited to urine or fecal matter, and may include any other fluid or material sample which could be loaded and examined within the cartridges, as described in the present disclosure and appreciated by one having ordinary skill in the art.

In non-limiting examples, the present subject disclosure describes specialized versatile cartridges especially designed to collect and present urine or fecal matter, while the urine or fecal matter are processed by a specialized versatile centrifuge. The versatile centrifuge, which may be used in conjunction with the present multi-sample type cartridge, may also be used in conjunction with two or more optical systems to analyze materials within the cartridge from multiple surfaces (e.g., a top or bottom surface) of the cartridge. A non-limiting example of such a centrifuge and optical system for use with the present cartridge design is the ELEMENT AIM system (HESKA CORPORATION, Loveland, Colo.). The present cartridges may be used in any instrument system which has the proper optical set up to view and analyze the samples contained within the present versatile cartridges (e.g., a standard microscope or an inverted, bottom up, microscope).

In one exemplary embodiment, the present subject disclosure is a cartridge. The cartridge includes an elongated body having a top side, and a bottom side; an elongated central chamber within the body and having a first end and a second end spanning a substantial length of the body; a first film covering a top portion of central chamber; a second film covering a bottom portion of the central chamber; a fill port positioned on the top side of the body and adapted to introduce fluid into the first end of the central chamber; and a hydrophobic filter positioned at the second end of the chamber.

In another exemplary embodiment, the present subject disclosure is a cartridge. The cartridge includes an elongated body having a top side, and a bottom side; an elongated central chamber within the body and having a first end and a second end spanning a substantial length of the body; a first transparent film covering a top portion of central chamber; a second transparent film covering a bottom portion of the central chamber; a fill port positioned on the top side of the body and adapted to introduce fluid into the first end of the central chamber; and a hydrophobic filter positioned at the second end of the chamber.

In yet another exemplary embodiment, the present subject disclosure is a cartridge. The cartridge includes an elongated body having a top side, and a bottom side; an elongated central chamber within the body and having a first end and a second end spanning a substantial length of the body; a first transparent film covering a top portion of central chamber; a second transparent film covering a bottom portion of the central chamber; a fill port positioned on the top side of the body and adapted to introduce fluid into the first end of the central chamber; a hydrophobic filter positioned at the second end of the chamber, wherein the hydrophobic filter is adapted to allow air to escape the chamber while a sample is being loaded and provides a slight positive pressure feedback to a user indicating the chamber is fully filled; and geometric features adapted to provide capability for interfacing with an instrument to align the cartridge consistently, retain the cartridge during centrifuge, move the cartridge through the instrument for processing, and hold the cartridge flat during optical scanning.

### BRIEF DESCRIPTION OF THE APPENDICES

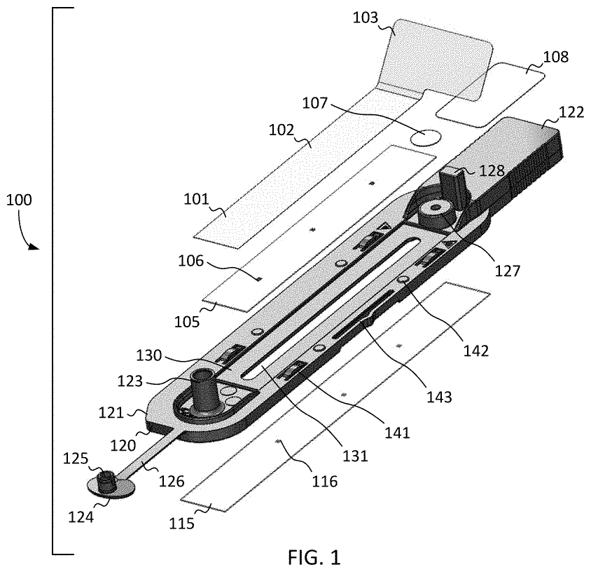

FIG. 1 shows an exploded perspective of a cartridge, according to an exemplary embodiment of the present subject disclosure.

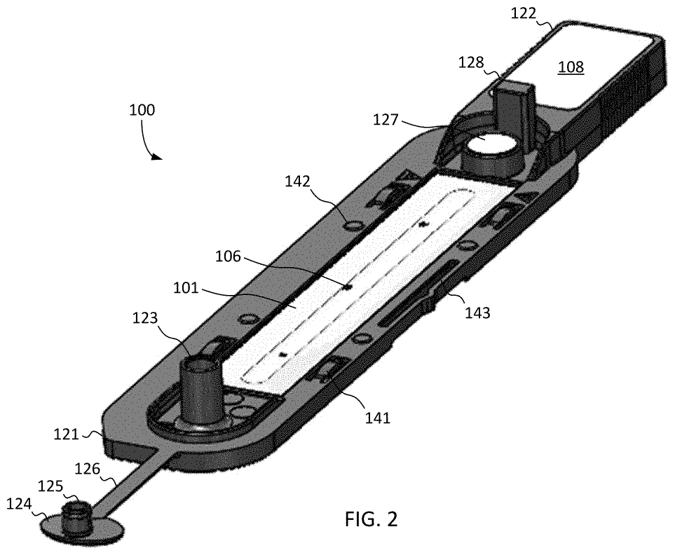

FIG. 2 shows a perspective view of a cartridge, according to an exemplary embodiment of the present subject disclosure.

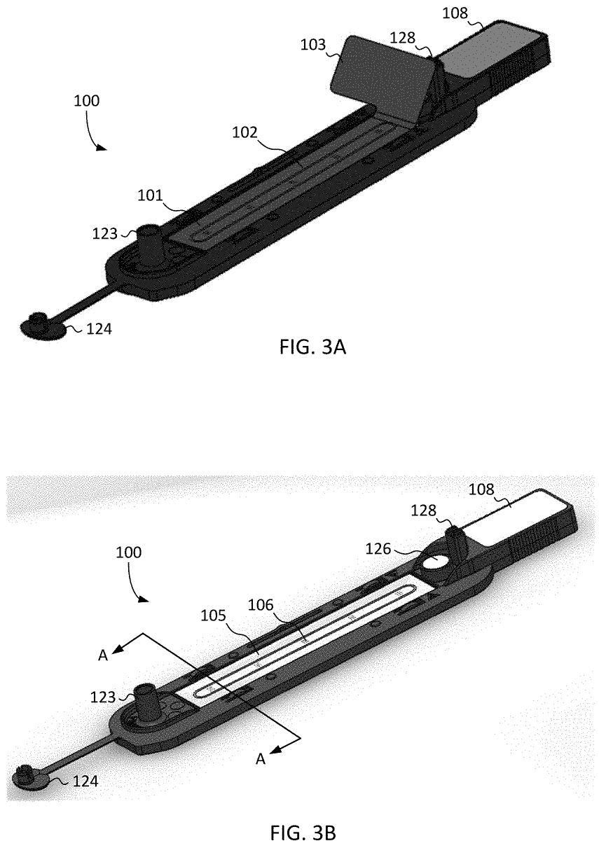

FIG. 3A shows a cartridge with protective film, according to an exemplary embodiment of the present subject disclosure.

FIG. 3B shows a cartridge with protective film removed, according to an exemplary embodiment of the present subject disclosure.

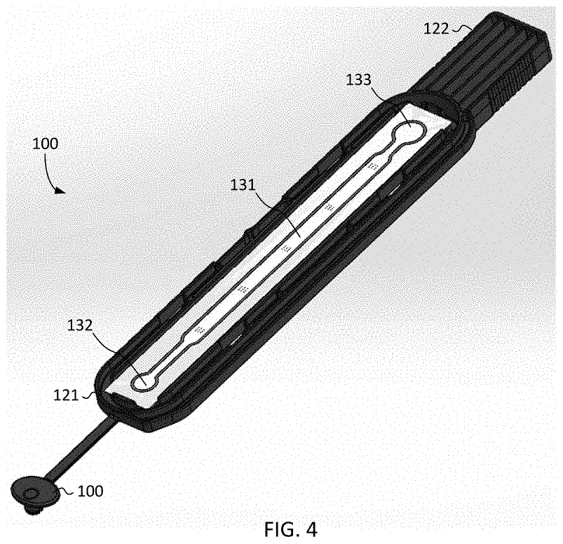

FIG. 4 shows a cartridge top portion removed to show interior sample chamber, according to an exemplary embodiment of the present subject disclosure.

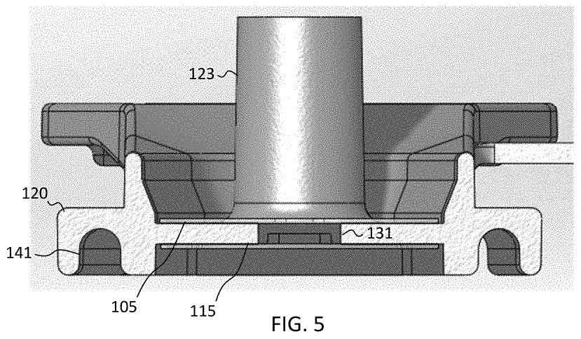

FIG. 5 shows a cut view of plane A-A of FIG. 3B, according to an exemplary embodiment of the present subject disclosure.

### DETAILED DESCRIPTION OF THE SUBJECT DISCLOSURE

The present subject disclosure presents versatile sample cartridges that allow for the even distribution of objects of interest throughout a sample viewing area. Whether the objects float on top of the sample or sink to the bottom of the sample, the sample chamber is an elongated channel which is designed to provide an efficient tool to detect and view such samples either from above or underneath. The cartridge and samples are described in detail below with respect to the specific examples of urine and fecal matter, but the cartridge is not restricted to such samples, and may be usable for any sample that may be viewed, assessed, processed, or evaluated in a centrifuge, analyzer, or other relevant instrument.

The cartridge is designed to be versatile and sample-independent in that it can be used for any variety of samples, including fecal or urine samples. The present single use cartridge allows for easy processing and disposal. The cartridge is designed to hold a statistically valid sample volume (either urine or fecal) and provide a transparent viewing area sufficient for rapid optical scanning. In one non-limiting exemplary embodiment, a cartridge is used which holds a minimum of 250 ul of sample (either urine or fecal) and provides a minimal optical viewing area of at least 250 sq. mm which can be optically imaged from the top or bottom. This sample volume allows for a full statistical representation of the sample being inspected.

The present subject disclosure addresses the routine and important task of prepping and analyzing different types of samples by a centrifuge or other analyzer or optical device on a single versatile cartridge. FIG. 1 shows an exploded view of an exemplary embodiment of a cartridge assembly 100 according to the present subject disclosure. The cartridge assembly 100 comprises a main body portion 120, a top transparent film 105 and a bottom transparent film 115. A further transparent protective film 101 is positioned atop the top transparent film 105.

As shown in FIGS. 1 and 3A-3B, the top transparent protective film 101 has an elongated portion 102 and an end portion 103. The top protective transparent film 101 is positioned atop the main body portion 120 during manufacture, and may be peeled off right before placing the cartridge 100 into a centrifuge or other processing or analyzing system. The end portion 103 does not have a removable adhesive portion and may be grasped and pulled off so that the elongated portion 102 may be separated from its reversibly adhesive attachment to the top portion of cartridge main body 120. The removable protective film 101 prevents any sample or contaminant from getting onto the top surface of the imaging chamber 131 during the sample introduction, and the protective film 101 is removed prior to inserting the cartridge 100 into the instrument.

The main body portion 120 has a first end 121 and a second end 122. The first end 121 includes a vertically positioned fill port 123. A sample to be analyzed is introduced into the cartridge 100 through the fill port 123, which has a longitudinal axis that is perpendicular to a longitudinal axis of the main body portion 120. After the fluid sample is introduced into the vertically positioned fill port 123, the fill port 123 may be sealed with a flexible cap portion 124. The cap portion 124 has a mating portion 125 which mates with the aperture of the fill port 123. A flexible neck portion 126 allows the cap portion 124 to stay clear of the fill port 123 during the introduction of the sample, but then bend to engage the mating portion 125 with the aperture of the fill port 123 after the cartridge chamber 131 is filled. A tethered cap 124 is included in the molded cartridge body 120, allowing the cartridge 100 to be sealed once the sample has been loaded into the cartridge.

The long, thin geometry of the cartridge 100 and imaging chamber 131, in the shape of an elongated channel, which allows for uniform filling of the sample and minimizes the height of the sample, letting target objects of interest either float to the top (e.g., fecal) or sediment to the bottom (e.g., urine) quickly.

The main body portion 120 has a central flow region 130 that includes the sample channel 131. The sample contained within the sample chamber 131 may be viewable and analyzed from both a top portion and a bottom portion of the cartridge 100. The sample chamber 131 is viewable from the top portion of the cartridge 100 through the top transparent film 105. Similarly, the sample chamber 131 is viewable from the bottom portion of the cartridge 100 through the bottom transparent film 115. Top transparent film 105 has one or more focus feature marks 106 which enable the proper focus and adjustment of analysis equipment (centrifuge, analyzers, etc.) onto the sample. Similarly, bottom transparent film 115 has one or more focus feature marks 116 which enable the proper focus and adjustment of analysis equipment (centrifuge, analyzers, etc.) onto the sample. Microscopic printing on the cartridge 100 allows for calibration of the optical system in the vertical direction for improved accuracy of object of interest identification.

The elements and components of the cartridge 100 may be composed of various materials. For example, the cartridge body portion 120 may be a suitable plastic (e.g., polycarbonate) body with a laser weld path for sample channel 131. The top film 105 and bottom film 115 may be transparent plastic (e.g., polycarbonate) film. Filter 107 may be a hydrophobic filter. The top protective film 101 may be a transparent protective film, and film 108 may be a writeable adhesive film. Writable label film 108 on the handle of the cartridge 100 provides a location for the user to identify the sample or patient ID that has been loaded into the cartridge. The top protective film 101 is designed to be removed after the cartridge 100 is filled. The hydrophobic filter 107 allows air to escape the cartridge 100 while the sample is being loaded and provides a slight positive pressure feedback to the user indicating the cartridge 100 is fully filled. Filter 107 may also include a color change feature which indicates when the sample has made contact with the filter 107, signifying that the chamber 131 is full of sample.

Geometric features in the cartridge 100 provide the capability for interfacing with an analysis instrument to align the cartridge consistently. For example, the central flow region 130 may include a poke yoke skirt design that promotes a pre-set loading position of the cartridge 100 into a corresponding instrument, and prevents the cartridge 100 from being inserted backwards/upside down into the host instrument. Further, centrifuge vertical Z axis hold down springs 141 retain the cartridge 100 while being spun in a centrifuge. Likewise, optical vertical Z axis hold down pads 142 control the cartridge 100 flatness when under a microscope of other analysis instrument. Finally, X datum spring 143 control lateral movement and hold against the optical datum during inspection. Other features or combination of such features may also be possible and are within the purview of one having skill in the art after consideration of the present disclosure. Geometric features in the cartridge provide capability for interfacing with the instrument to align the cartridge consistently, retain the cartridge during centrifuge, move the cartridge through the instrument for processing, and hold the cartridge flat during optical scanning.

The second end 122 of the cartridge 100 includes a push pillar 128 having an axis which is perpendicular to the long axis of the main body portion 120. The longitudinal axes of the fill port 123, the hydrophobic port 127, and the push pillar 128 are in parallel. The push pillar 128 allows an instrument stage in a host instrument to move cartridge 100 into and out of, for example, a centrifuge and through the instrument.

FIGS. 3A-3B show an example of a cartridge 100 as manufactured, and before use in a host instrument, and when ready for use in a host instrument, respectively. FIG. 3A is how the cartridge 100 may look during filling of the fill port 123 with a sample. After the sample is loaded onto the cartridge 100 through fill port 123, the upper protective film 101 may be removed, as shown in FIG. 3B, to allow for analysis of the sample contained within sample chamber 131. Cap 124 would also be fit onto the fill port 123 aperture to ensure proper containment of the sample within the sample channel 131.

As shown in FIG. 4, the sample channel 131 extends the longitudinal axis of the cartridge 100, with a fill port chamber 132 on one end and a hydrophobic port chamber 133 on the other end.

The fill port 123 directs a sample fluid into the sample channel 131. As shown in FIG. 5, the sample channel 131 is defined by a volume having the top transparent film 105 and the bottom transparent film 115, and the body of the main body portion 120. The hydrophobic filter 107 allows air to escape the cartridge while the sample is being loaded and provides a slight positive pressure feedback to the user indicating the cartridge is fully filled.

In one exemplary embodiment, the sample chamber 131 is a minimum 62.5 mm long, 4 mm wide, and 1 mm deep (height). This produces a minimum volume of 250 uL, which is ideal for viewing a sample of urine or fecal matter. The length to width ratio is roughly 15, while the width to height ratio is 4. Various ranges are also possible. For example, the length to width ratio could be up to 250, and the width to height ration up to 1. Alternatively, the length to width ration could be 10, and the width to height ration could be 0.5 Thus, the same cartridge with the same chamber size may be used to view and analyze different samples, including a urine sample and a fecal matter sample. A unique aspect of the present cartridge that allows for flexibility in viewing and examining different samples from the top and the bottom of the cartridge is the elongated and thin sample chamber, which allows for more even distribution of sample within the chamber while minimizing the bunching of the sample at the edges, as would be evident in cartridges with wider width/shorter length sample chambers.

The present subject disclosure is effective based on a centrifuge theory of samples in a thin chamber. Objects of interest (OOIs) are positioned at various Z levels before centrifugation. After centrifugation using a flat elongated chamber cartridge 100 as described herein, the OOIs become positioned at the same level after centrifugation using a vertically spinning centrifuge. Using this technique, the OOIs are not flocculated or clumped together but spread out across a horizontal plane. Once the centrifugation is completed, a top view and a bottom image may be made of the OOIs. Urine based OOIs are typically at the bottom surface, and fecal based OOIs are typically at the top surface.

Numerous unique attributes of the multi-sample cartridge are evident to one having ordinary skill in the art. Besides the functional aspects highlighted above, additional features are noted. For example, the aspect ratio of the cartridge sample chamber 131, in combination with the means and orientation of the centrifugation, optimizes the sample distribution over the optical area 131 through minimization and control of the Coriolis forces. Further, sample volume allows for a full statistical representation of the sample being inspected. The cartridge 100 in combination with a host instrument allows for universal application of a single versatile cartridge to multiple different samples, including urine and fecal samples. The exemplary cartridge 100 described herein is but one example of a versatile cartridge according to the present subject disclosure. Other embodiments are also within the scope of the present disclosure.

As employed in this specification and annexed drawings, the term “or” is intended to mean an inclusive “or” rather than an exclusive “or.” Moreover, articles “a” and “an” as used in the subject specification and annexed drawings should generally be construed to mean “one or more” unless specified otherwise or clear from context to be directed to a singular form.

What has been described above includes examples that provide advantages of the subject disclosure. It is, of course, not possible to describe every conceivable combination of components or methodologies for purposes of describing the subject disclosure, but one of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The illustrations and examples provided herein are for explanatory purposes and are not intended to limit the scope of the appended claims. It will be recognized by those skilled in the art that changes or modifications may be made to the above described embodiment without departing from the broad inventive concepts of the subject disclosure. It is understood therefore that the subject disclosure is not limited to the particular embodiment which is described, but is intended to cover all modifications and changes within the scope and spirit of the subject disclosure.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed is:

1. A cartridge, comprising:
an elongated body having a top side, and a bottom side;
an elongated central chamber within the body and having a first end and a second end spanning a substantial length of the body;
a first film covering a top portion of central chamber;
a second film covering a bottom portion of the central chamber;
a fill port positioned on the top side of the body and adapted to introduce fluid into the first end of the central chamber; and
a hydrophobic filter positioned at the second end of the chamber.

2. The cartridge in claim 1, further comprising a peel off transparent protective film covering the first film.

3. The cartridge in claim 1, wherein the central chamber holds a minimum of 250 uL of sample.

4. The cartridge in claim 3, wherein the central chamber is at least 62.5 mm long, 4 mm wide, and 1 mm deep.

5. The cartridge in claim 1, wherein the first film and the second film are both transparent to be able to view and image any sample within the chamber from the top portion or the bottom portion.

6. The cartridge in claim 5, wherein a viewing area is a minimum of 250 mm².

7. The cartridge in claim 1, further comprising a tethered cap for connecting to the fill port and sealing any sample within the central chamber.

8. The cartridge in claim 1, wherein the hydrophobic filter is adapted to allow air to escape the chamber while a sample is being loaded and provides a slight positive pressure feedback to a user indicating the chamber is fully filled.

9. The cartridge in claim 1, further geometric features adapted to provide capability for interfacing with an instrument to align the cartridge consistently, retain the cartridge during centrifuge, move the cartridge through the instrument for processing, and hold the cartridge flat during optical scanning.

10. The cartridge in claim 9, wherein the geometric features include optical Z hold down pads to control cartridge flatness when under microscope.

11. The cartridge in claim 9, wherein the geometric features include a poke yoke skirt to prevent the cartridge from being inserted backwards into the instrument.

12. The cartridge in claim 9, wherein the geometric features include a push pillar which allows an instrument stage to move the cartridge into and out of the centrifuge and through the instrument.

13. The cartridge in claim 9, wherein the geometric features include a X-datum spring to control lateral movement and hold against an optical datum during inspection.

14. The cartridge in claim 9, wherein the geometric features include a centrifuge Z hold down springs which retain the cartridge when being spun in the centrifuge.

15. The cartridge in claim 9, further comprising web and ribs for longitudinal bracing.

16. The cartridge in claim 1, further comprising laser etched microscopic features on the first film or second film for improved optical calibration and object identification accuracy.

17. A cartridge, comprising:
an elongated body having a top side, and a bottom side;
an elongated central chamber within the body and having a first end and a second end spanning a substantial length of the body;
a first transparent film covering a top portion of central chamber;
a second transparent film covering a bottom portion of the central chamber;
a fill port positioned on the top side of the body and adapted to introduce fluid into the first end of the central chamber; and
a hydrophobic filter positioned at the second end of the chamber.

18. The cartridge in claim 17, wherein the hydrophilic filter is adapted to allow air to escape the chamber while a sample is being loaded and provides a slight positive pressure feedback to a user indicating the chamber is fully filled.

19. The cartridge in claim 17, further geometric features adapted to provide capability for interfacing with an instrument to align the cartridge consistently, retain the cartridge during centrifuge, move the cartridge through the instrument for processing, and hold the cartridge flat during optical scanning.

20. A cartridge, comprising:
an elongated body having a top side, and a bottom side;
an elongated central chamber within the body and having a first end and a second end spanning a substantial length of the body;
a first transparent film covering a top portion of central chamber;
a second transparent film covering a bottom portion of the central chamber;
a fill port positioned on the top side of the body and adapted to introduce fluid into the first end of the central chamber;
a hydrophobic filter positioned at the second end of the chamber, wherein the hydrophobic filter is adapted to allow air to escape the chamber while a sample is being loaded and provides a slight positive pressure feedback to a user indicating the chamber is fully filled; and
geometric features adapted to provide capability for interfacing with an instrument to align the cartridge consistently, retain the cartridge during centrifuge, move the cartridge through the instrument for processing, and hold the cartridge flat during optical scanning.
